(19) United States
(12) Patent Application Publication
(10) Pub. No.: US 2026/0266608 A1
(43) Pub. Date: Sep. 10, 2026

(54) Surveying Instrument

(71) Applicant: TOPCON CORPORATION, Tokyo-to (JP)

(72) Inventors: Hiroki Saitoh, Tokyo-to (JP); Toshiki Arai, Tokyo-to (JP); Mayo Kurooka, Tokyo-to (JP); Hiroshi Hashimoto, Tokyo-to (JP); Shigeki Eguchi, Tokyo-to (JP); Yoshiyuki Daibo, Tokyo-to (JP)

(21) Appl. No.: 19/555,738

(22) Filed: Mar. 3, 2026

(30) Foreign Application Priority Data
Mar. 6, 2025 (JP) 2025-035529

(51) Int. Cl. G01C 15/00; G01B 21/22

(52) U.S. Cl. CPC G01C 15/002; G01B 21/22

(57) ABSTRACT

A rotating part 6 that houses a collimation optical system is rotatably supported on a frame via a rotation shaft 8 with a horizontal axis, one end of the rotation shaft is supported on the frame via a ball bearing 15, the other end of the rotation shaft is supported on the frame via a sliding bearing 24, an electric motor 11 is provided at the one end, and a vertical angle detector 12 is provided at the other end.

### TECHNICAL FIELD

The present disclosure relates to a surveying instrument having a rotating part that houses a collimation optical system.

### BACKGROUND ART

In surveying instruments, such as total stations, a telescope unit, which serves as a vertical rotating part housing the collimation optical system, is configured to be rotatably supported on a frame via a horizontal shaft and to be driven to rotate in a vertical direction by a motor connected to the horizontal shaft.

If an error occurs in a support part of the horizontal shaft due to the rotation of the telescope unit, the error will affect a measurement accuracy, so it is desirable that a drive motor and bearing structure are a support structure so as not to generate errors.

Conventionally, an ultrasonic motor has been used as drive motor, and a sliding bearing has been used as bearing. The sliding bearing can support a shaft with high precision, but it requires a small gap for the shaft to rotate. For this reason, although a delicate matter, a state in which the shaft is in contact with a lower end of the sliding bearing due to gravity acting on the rotating part becomes a reference position.

Further, in the ultrasonic motor, a stator and a rotor are in solid contact, and the rotor rotates by vibrations generated between the stator and the rotor, providing high stability when the rotor rotates. Therefore, a structure, in which the ultrasonic motor is used as a rotary drive source and the shaft of the rotating part is supported by the sliding bearing, provides high precision and stability.

On the other hand, in the ultrasonic motor, the stator and rotor are in solid contact with each other, so wear is unavoidable, and the ultrasonic motor may affect a life of the surveying instrument.

### Prior Art References

### Patent Document

### Patent Document 1

Japanese Patent Publication No. 63-13126

### SUMMARY OF THE INVENTION

### Problem to be Solved by the Invention

The present disclosure provides a surveying instrument that enables a use of an electric motor instead of an ultrasonic motor as a rotational power for the telescope unit.

### Means for Solving the Problem

The present disclosure relates to a surveying instrument comprising a rotating part that houses a collimation optical system, wherein the rotating part is rotatably supported on a frame via a rotation shaft with a horizontal axis, one end of the rotation shaft is supported on the frame via a ball bearing, the other end of the rotation shaft is supported on the frame via a sliding bearing, an electric motor is provided at the one end, and a vertical angle detector is provided at the other end.

### Effects of the Invention

According to the present disclosure, one end of a rotation shaft is supported via a ball bearing, thereby an electric motor becomes capable of being used at the one end. The other end is supported via a sliding bearing, and a support accuracy of the rotation shaft is maintained, thereby it is possible to use an electric motor as a rotational power in a surveying instrument.

### BRIEF DESCRIPTION OF DRAWINGS

FIG. 1 is a schematic overall view of a surveying instrument according to the present disclosure.

FIG. 2 is a cross-sectional elevation view of a bearing structure of the surveying instrument.

FIG. 3 is a view taken along an arrow A in FIG. 2.

### MODES FOR CARRYING OUT THE INVENTION

A description will be given below on an embodiment of the present disclosure by referring to the attached drawings.

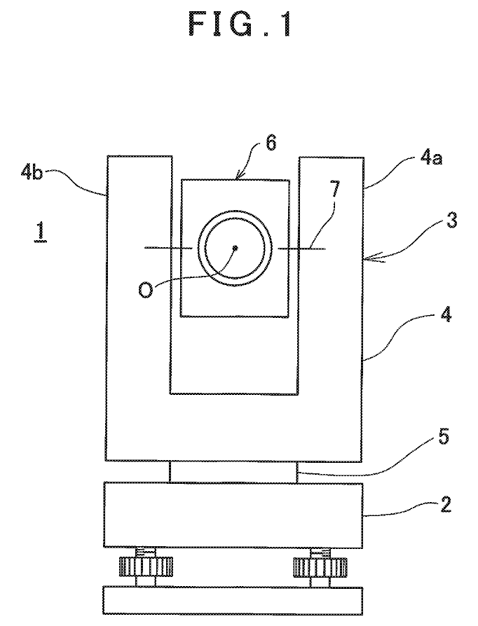

FIG. 1 is a schematic overall view of a surveying instrument 1 according to the present embodiment. In FIG. 1, reference numeral 2 denotes a leveling module, and reference numeral 3 denotes a surveying instrument main body. First, a description will be given on an outline of the surveying instrument 1. In the following description, “up and down” refers to up and down in FIG. 1, and “left and right” refers to left and right in FIG. 1.

The surveying instrument main body 3 is provided on the leveling module 2, and the surveying instrument main body 3 is leveled in a horizontal state by the leveling module 2.

The surveying instrument main body 3 has a frame 4 as a horizontal rotation unit, a horizontal rotation driver 5, and a telescope unit 6 as a vertical rotation unit. The horizontal rotation driver 5 is located at a lower end of the frame 4, is attached to the leveling module 2, and supports the frame 4 such that the frame 4 can rotate horizontally. In the drawing, O indicates a center of the telescope unit 6.

The frame 4 has a right arm section 4a and a left arm section 4b, and the telescope unit 6 is accommodated in a space formed between the right arm section 4a and the left arm section 4b, and the telescope unit 6 is arranged to be rotatable around a horizontal axis 7 in a vertical direction.

The telescope unit 6 incorporates a distance measuring module (not shown) and an optical system (not shown), and the distance measuring module emits a modulated laser beam or pulsed light via the optical system as a distance measuring light toward an object (not shown), receives a reflected light from the object, and measures distance based on a time difference between an emission and a reception of the distance measuring light and a light velocity.

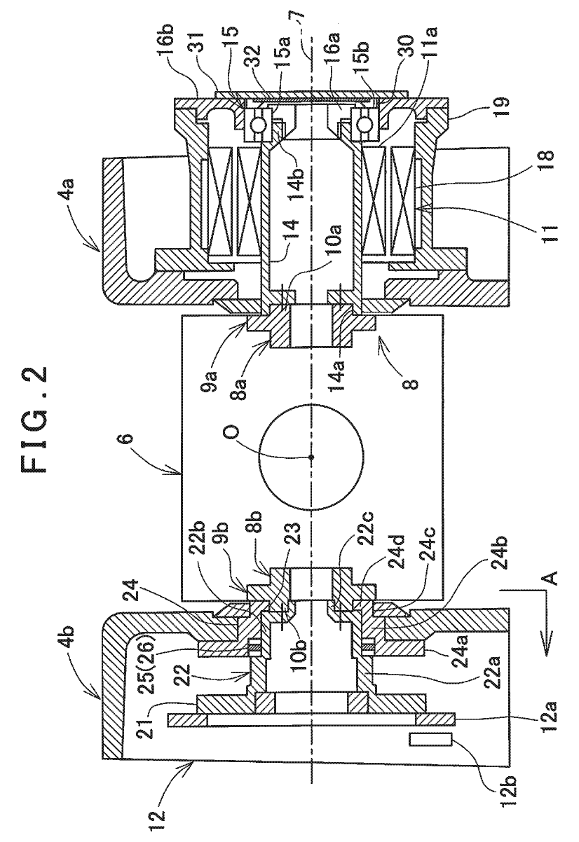

Further, a horizontal rotation angle of the frame 4 and a vertical rotation angle of the telescope unit 6 are detected by a horizontal angle detector (not shown) and a vertical angle detector (see FIG. 2), respectively.

Based on a distance measurement result, a detected horizontal angle, and a detected vertical angle, three-dimensional data of a measurement point or the object is determined.

Next, a description will be given on a vertical rotation mechanism of the telescope unit 6 by referring to FIG. 2.

The telescope unit 6 is supported by the frame 4 via a rotation shaft 8 that is concentric with the horizontal axis 7.

The rotation shaft 8 includes a horizontal shaft 8a and a horizontal shaft 8b protruding from both left and right sides of the telescope unit 6. The horizontal shaft 8a and the horizontal shaft 8b are hollow and provided integrally with the telescope unit 6 and concentrically with the horizontal axis 7.

The horizontal shaft 8a is provided at a right end of the telescope unit 6 in FIG. 1, and the horizontal shaft 8b is provided at a left end of the telescope unit 6 in FIG. 1.

The horizontal shaft 8a has a flange 9a and a convex portion 10a protruding rightward from the flange 9a, and the flange 9a and the convex portion 10a are formed concentrically with the horizontal axis 7.

The horizontal shaft 8b has a flange 9b and a convex portion 10b protruding leftward from the flange 9b, and the flange 9b and the convex portion 10b are formed concentrically with the horizontal axis 7.

A vertical rotation motor 11 is accommodated in a portion of the right arm section 4a facing the telescope unit 6, and the vertical rotation motor 11 is connected to one end (a right end in the drawing) of the rotation shaft 8. A vertical angle detector 12 is accommodated in a portion of the left arm section 4b facing the telescope unit 6, and the vertical angle detector 12 is connected to the other end (a left end in the drawing) of the rotation shaft 8.

In the present disclosure, an electric motor driven by electromagnetic force is applied as the vertical rotation motor 11.

The vertical rotation motor 11 has a hollow rotation shaft 14 that is concentric with the horizontal axis 7, and a fitting recess portion 14a is formed at a tip (left end in the drawing) of the rotation shaft 14. The convex portion 10a fits into and is fixed to the fitting recess portion 14a, and the horizontal shaft 8a and the rotation shaft 14 are integrated. One end of the rotation shaft 8 is constituted of the rotation shaft 14 and the horizontal shaft 8a.

A shaft end portion 14b is formed at a base end (a right end in the drawing) of the rotation shaft 14, and the shaft end portion 14b is fitted into an inner ring 15a of a ball bearing 15. An inner ring holder 16a is fitted into the inner ring 15a. The inner ring holder 16a is fitted into the shaft end portion 14b and is connected by screws. By tightening the inner ring holder 16a, the inner ring 15a is held between the shaft end portion 14b and the inner ring holder 16a, and is integrated with the rotation shaft 14.

In the rotation shaft 14, a rotor 11a of the vertical rotation motor 11 is provided integrally with the rotation shaft 14.

A stator holder 19 is provided on the right arm section 4a concentrically with the horizontal axis 7, and the stator 18 of the vertical rotation motor 11 is provided on the stator holder 19. An outer ring holder 16b is provided on the stator holder 19, and an outer ring 15b of the ball bearing 15 is held by the outer ring holder 16b.

Therefore, the ball bearing 15 is held concentrically with the horizontal axis 7 by the inner ring holder 16a and the outer ring holder 16b.

The shaft end portion 14b is rotatably supported by the right arm section 4a via the ball bearing 15, the outer ring holder 16b and the stator holder 19.

Further, the rotor 11a is supported without contact with the stator 18, and the rotor 11a rotates when a voltage is impressed to the rotor 11a and the stator 18. While the rotor 11a is rotating, an attractive and repulsive electromagnetic force acts between the rotor 11a and the stator 18, but the ball bearings 15 maintain an axis of the rotor 11a concentric with the horizontal axis 7.

As described above, the vertical angle detector 12 is connected to the horizontal shaft 8b. The vertical angle detector 12 has a protractor board 12a, a sensor 12b that is provided opposite the protractor board 12a and detects a rotation of the protractor board 12a, and a flange 21.

The flange 21 is provided concentrically with the horizontal axis 7, and the protractor board 12a is provided concentrically with the flange 21.

The flange 21 has a shaft portion 22 as a rotation shaft, and the shaft portion 22 protrudes to the right in the drawing (towards the center of the telescope unit 6) and has a stepped shape whose diameter gradually becomes thinner, a thick shaft portion 22a with a large diameter, an intermediate shaft portion 22b with a medium diameter, and a thin shaft portion 22c with the thinnest diameter.

The intermediate shaft portion 22b has a larger diameter than the convex portion 10b, and a groove 23 is formed between the intermediate shaft portion 22b and the convex portion 10b. The thin shaft portion 22c is fitted and fixed to the inside of the convex portion 10b, and the flange 21, i.e., the protractor board 12a, is integrated with the horizontal shaft 8b.

A sliding bearing 24 is provided at a portion where the shaft portion 22 and the convex portion 10b pass through the left arm section 4b. The sliding bearing 24 has a disc portion 24a, a cylindrical first fitting portion 24b that protrudes toward the center (to the right in the drawing) from the disc portion 24a, and a second fitting portion 24c that is formed toward the center from the first fitting portion 24b. Further, the second fitting portion 24c protrudes toward the horizontal axis 7 and has an inner rim 24d that fits into the groove 23.

The disc portion 24a is fixed to the left arm section 4b by a screw, the first fitting portion 24b is in sliding contact with the thick shaft portion 22a, the first fitting portion 24b functions as a sliding bearing for the intermediate shaft portion 22b, and further the inner rim 24d is in sliding contact with the convex portion 10b and functions as a sliding bearing for the convex portion 10b. The horizontal shaft 8b, and the shaft portion 22 integrated with the horizontal shaft 8b are rotatably supported by the sliding bearing 24, and are supported by the left arm section 4b via the sliding bearing 24. The shaft portion 22 and the horizontal shaft 8b constitute the other end of the rotation shaft 8.

A recess portion is formed on an inner edge of the left end side of the first fitting portion 24b of the sliding bearing 24, and a ring-shaped spring storage portion 25 is formed between the recess portion and the thick shaft portion 22a. A spring 26 is provided in a compressed state in the spring storage portion 25, and the spring 26 biases the shaft portion 22 and the sliding bearing 24 in a direction away from each other.

The spring 26 may be any elastic ring with elasticity, such as a leaf spring, a coil spring, a rubber ring, etc. In the present embodiment, a wave washer is used.

As described above, the sliding bearing 24 is fixed to the left arm section 4b via the disc portion 24a, and the horizontal shaft 8b, the telescope unit 6 and the rotation shaft 14 which are integrated with the horizontal shaft 8b are biased leftward in the drawing by the bias of the spring 26. Further, the flange 9b abuts against the right end of the second fitting portion 24c. The movement of the horizontal shaft 8b in a horizontal direction is restricted. Thereby, this right end serves as a reference. The positions of the horizontal shaft 8b and the telescope unit 6 in the direction of the horizontal axis 7 are determined.

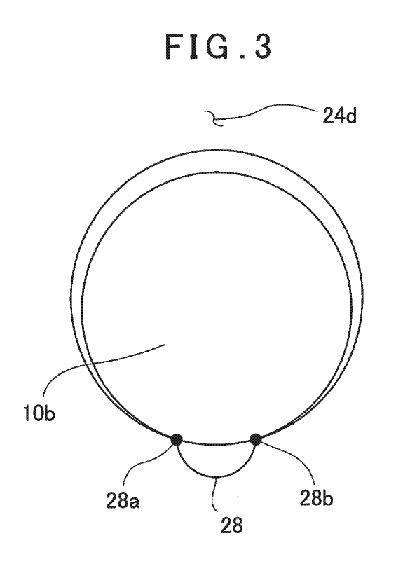

Next, a description will be given on a relationship between the second fitting portion 24c and the convex portion 10b by referring to FIG. 3. FIG. 3 is a view taken along an arrow A in FIG. 2, and is exaggerated for ease of explanation.

To allow rotation in the sliding bearing 24, a gap, although minute, is required between the second fitting portion 24c and the convex portion 10b.

In the present embodiment, the sliding bearing 24 has the following structure in order to prevent instability of the horizontal shaft 8b due to the gap.

A recess portion 28 formed of a cylindrical surface (concentric with the horizontal axis 7) is provided at the lowest position of an inner peripheral surface of the inner rim 24d. By providing the recess portion 28, boundaries 28a, 28b are formed between the recess portion 28 and the inner peripheral surface. Gravity acting on the telescope unit 6 (including the vertical angle detector 12, etc.) causes the inner rim 24d to abut against the boundaries 28a, 28b.

The inner rim 24d abuts against two points on the boundaries 28a and 28b, and thereby a position in a radial direction of the inner rim 24d is determined.

Therefore, the position of the telescope unit 6 in the radial direction and thrust direction is determined by the sliding bearing 24, and the sliding bearing 24 serves as a reference in the radial direction and thrust direction.

In the surveying instrument, the vertical rotation speed of the telescope unit 6 is about 180 deg/sec to 360 deg/sec, and the rotation of the telescope unit 6 does not make the position of the convex portion 10b unstable.

As described above, since the vertical angle detector 12 is provided on the side of the sliding bearing 24, the detection accuracy of the vertical angle detector 12 is maintained at a high level.

In the ball bearing 15, there is a gap necessary for rotation, although it is very small, between the inner ring 15a, balls, and outer ring 15b. Therefore, when the rotation shaft 14 rotates, it is thought that the rotation shaft 14 will wobble by the amount of this gap due to the electromagnetic force acting between the rotor 11a and the stator 18. On the other hand, because the horizontal shaft 8b is supported with high precision in both the radial and thrust directions by the sliding bearing 24, it is thought that even if the rotation shaft 14 wobble due to the very small gap in the ball bearing 15, almost no measurement error will occur.

Next, the measurement accuracy can be further improved by suppressing the occurrence of errors due to the gaps in the ball bearing 15. A description will be given below on a configuration for suppressing the gaps in the ball bearing 15.

In the support structure of the ball bearing 15, the inner ring 15a is fitted onto the shaft end portion 14b, and is held between the shaft end portion 14b and the inner ring holder 16a, and is integrated with the rotation shaft 14. On the other hand, the outer ring 15b is only fitted into the outer ring holder 16b, and is not completely fixed in the axial direction.

A ring 30 is provided so as to contact only the outer ring 15b, and a ring press member 31 is attached to the outer ring holder 16b. A cross section of the ring 30 has a shape that forms a ring-shaped gap between the ring 30 and the ring press member 31, and a biasing member 32 is provided in the gap.

The biasing member 32 has a function of biasing the outer ring 15b in the axial direction, toward the center of the telescope unit 6. The rotation shaft 14 is integral with the telescope unit 6 and the horizontal shafts 8a and 8b, and the flange 9b of the horizontal shaft 8b abuts against the inner rim 24d, thereby defining the axial position. Therefore, the biasing force of the biasing member 32 applies pre-load between the inner ring 15a, the balls, and the outer ring 15b, thereby suppressing any gap. Therefore, wobble of the rotation shaft 14 is suppressed.

The biasing member 32 may be any member capable of generating a biasing force, and in the present embodiment, a wave washer is used. Further, the biasing member 32 may be an elastic body such as rubber, and for example, an O-ring may be used instead of a wave washer. Alternatively, the ring 30 may be omitted, and an O-ring may be directly provided between the outer ring 15b and the ring press member 31.

Although the outer ring 15b is biased in the axial direction as a means for preventing the gap in the ball bearing 15, the inner ring 15a may also be biased in the radial direction. For example, an annular convex portion (not shown) may be formed on the right end face of the inner ring holder 16a (the end face on the side away from the center of the telescope unit 6), and a biasing member 32 such as a leaf spring may be provided that biases one end of the rotation shaft 8 downward via the convex portion.

Some or all of the above embodiments can be described as, but not limited to, the following supplementary notes.

### Note

1. A surveying instrument comprising: a rotating part that houses a collimation optical system, wherein the rotating part is rotatably supported on a frame via a rotation shaft with a horizontal axis, one end of the rotation shaft is supported on the frame via a ball bearing, the other end of the rotation shaft is supported on the frame via a sliding bearing, an electric motor is provided at the one end, and a vertical angle detector is provided at the other end.

2. The surveying instrument according to paragraph 1, wherein the one end is configured by connecting a horizontal shaft fixed to the rotating part with a rotation shaft of the electric motor, an inner ring of the ball bearing is fixed to an end of the rotation shaft on a side opposite to a center, an outer ring is held by an outer ring holder, and a biasing member that biases the outer ring toward a center side is provided.

3. The surveying instrument according to paragraph 1, wherein the other end is configured by connecting a horizontal shaft fixed to the rotating part with a shaft portion serving as a rotation shaft of the vertical angle detector, the sliding bearing is fixed to the frame, the shaft portion has a stepped shape including a thick shaft portion, an intermediate shaft portion, and a thin shaft portion, an elastic ring for biasing the shaft portion and the sliding bearing in a direction away from each other is provided between the thick shaft portion and the sliding bearing, the horizontal shaft has a flange, and the flange abuts against the end face on the center side of the sliding bearing due to the biasing force of the elastic ring, and a position of the horizontal shaft in an axial direction is restricted.

4. The surveying instrument according to paragraph 1, further comprising a biasing member for biasing one end of the rotation shaft downward.

5. The surveying instrument according to paragraphs 2 or 4, wherein the biasing member is either a wave washer or an O-ring.

6. The surveying instrument according to paragraph 3, wherein the elastic ring is any one of a wave washer, a leaf spring, a coil spring, and a rubber ring.

### REFERENCE SIGNS LIST

1 Surveying instrument

2 Leveling module

3 Surveying instrument main body

4 Frame

6 Telescope unit

8 Rotation shaft

9b Flange

11 Vertical rotation motor

12 Vertical angle detector

14 Rotation shaft

15 Ball bearing

19 Stator holder

21 Flange

22 Shaft portion

24 Sliding bearing

26 Spring

1. A surveying instrument comprising: a rotating part that houses a collimation optical system, wherein the rotating part is rotatably supported on a frame via a rotation shaft with a horizontal axis, one end of said rotation shaft is supported on said frame via a ball bearing, the other end of said rotation shaft is supported on said frame via a sliding bearing, an electric motor is provided at said one end, and a vertical angle detector is provided at said other end.

2. The surveying instrument according to claim 1, wherein said one end is configured by connecting a horizontal shaft fixed to said rotating part with a rotation shaft of said electric motor, an inner ring of said ball bearing is fixed to an end of said rotation shaft on a side opposite to a center, an outer ring is held by an outer ring holder, and a biasing member that biases said outer ring toward a center side is provided.

3. The surveying instrument according to claim 1, wherein said other end is configured by connecting a horizontal shaft fixed to said rotating part with a shaft portion serving as a rotation shaft of said vertical angle detector, said sliding bearing is fixed to said frame, said shaft portion has a stepped shape including a thick shaft portion, an intermediate shaft portion, and a thin shaft portion, an elastic ring for biasing said shaft portion and said sliding bearing in a direction away from each other is provided between said thick shaft portion and said sliding bearing, said horizontal shaft has a flange, and said flange abuts against the end face on the center side of the sliding bearing due to the biasing force of the elastic ring, and a position of the horizontal shaft in an axial direction is restricted.
